(19) United States
(12) Patent Application Publication
(10) Pub. No.: US 2023/0278021 A1
(43) Pub. Date: Sep. 7, 2023

(54) SOLID SHAPED BODY AND USE OF THE SOLID SHAPED BODY

(71) Applicant: BASF SE, Ludwigshafen am Rhein (DE)

(72) Inventors: Marcelo Daniel KAUFMAN RECHULSKI, Ludwigshafen am Rhein (DE); Miguel Angel ROMERO VALLE, Ludwigshafen am Rhein (DE)

(21) Appl. No.: 18/018,048

(22) PCT Filed: Jul. 23, 2021
(86) PCT No.: PCT/EP2021/070655

§ 371 Date: Jan. 26, 2023

(30) Foreign Application Priority Data
Jul. 29, 2020 (EP) 20188346.9

(51) Int. Cl. B01J 35/02; B01J 23/755; B01J 37/00; B01J 19/30

(52) U.S. Cl. CPC B01J 35/026; B01J 23/755; B01J 35/023; B01J 37/0009; B01J 19/30; B01J 2219/30296

(57) ABSTRACT

The invention relates to a solid shaped body (1) having a cylindrical form with a first base area (3), a second base area (5) and a lateral area (7), wherein the solid shaped body (1) comprises a first number of flutes (9) in the lateral area (7), each extending from the first base area (3) to the second base area (5), and a second number of openings (11), each extending from the first base area (3) to the second base area (5), and wherein the second number of openings (11) is in a range from 2 to 8, the second number of openings (11) is larger than the first number of flutes (9) and wherein a ratio between a first radius (13) of at least one flute (9) and a second radius (15) of at least one opening (11) is at least 1.15. The invention further relates to a use of the solid shaped body (1).

The present invention relates to a solid shaped body having a cylindrical form with a first base area, a second base area and a lateral area, wherein the solid shaped body comprises a first number of flutes in the lateral area, each extending from the first base area to the second base area, and a second number of openings, each extending from the first base area to the second base area. The invention further relates to a use of the solid shaped body as a catalyst.

The performance of solid shaped bodies, especially when used as catalysts, strongly depends on the shape and thus on the geometry of the shaped bodies. Mechanical strength, pressure drop, packing bed density and bed mass diffusion coefficient constitute examples of performance indicators. Further important parameters are the weight of a single solid shaped body, the specific surface area and heat transport as well as mass transport properties.

Solid shaped bodies are for example applied in reforming of hydrocarbons to synthesis gas, in which Ni- or Co-containing oxide-based catalysts can be used.

WO 2013/118078 A1 refers to a hexaaluminate-comprising catalyst for reforming of hydrocarbons and a reforming process. Catalysts are prepared as bulk material, tablets or strands.

EP 2 323 762 B1 describes shaped hydrogenous catalyst bodies possessing an equal number of holes and flutes.

DE 27 19 543 A1 discloses ceramic bodies for an incorporation of a catalyst. Cylinders with a circular outer circumference are illustrated.

DE 39 35 073 A1 discloses a process for catalytic dehydrogenation of hydrocarbons. Catalyst bodies in form of a gear wheel with rectangular cocks are applied.

WO 2007/051602 A1 relates to a shaped catalyst body for preparing maleic anhydride. A shaped catalyst body in form of a prism providing two triangular faces is proposed.

35 WO 2020/120078 A1 is directed to a catalytic system comprising a tubular reactor and at least one catalyst particle located within the tubular reactor. A relationship between the form of the catalytic particles and the form of the tubular reactor is considered to improve heat transfer conditions.

U.S. Pat. No. 4,441,990 refers to cross-section shapes such as rectangular shaped tubes and triangular shaped tubes, which are employed to form catalytic extrudates which may be used in hydrocarbon processing operations.

DE 31 41 942 A1 is directed to catalytic shaped bodies in form of cylinders, which have a specific circumference with convexities being wider than concavities.

WO 2010/029324 A1 is directed to a catalyst unit comprising a cylinder, which exhibits five holes arranged in a pentagonal pattern as well as five riffles.

WO 2006/114320 A1 describes a cylindrical catalyst member, wherein embossings are provided on the circumferential surface of the catalyst member.

Often, geometries of catalytic solid shaped bodies are optimized with regard to only one performance indicator such as pressure drop or surface area, whereas other performance indicators are rather neglected. It is an objective of the present invention to provide solid shaped bodies, which provide an improvement in at least one performance indicator, whereas at the same time a good performance is shown for remaining performance indicators. Thus, the solid shaped bodies shall offer a directed compromise between various performance indicators comprising pressure drop, surface area, mechanical strength, weight of a single shaped body, packed bed density, specific surface area of the packed bed, heat transport properties and mass transport properties.

This object is achieved by a solid shaped body having a cylindrical form with a first base area, a second base area and a lateral area, wherein the solid shaped body comprises a first number of flutes in the lateral area, each extending from the first base area to the second base area, and a second number of openings, each extending from the first base area to the second base area, and wherein the second number of openings is in a range from 2 to 8, the second number of openings is larger than the first number of flutes and wherein a ratio between a first radius of at least one flute and a second radius of at least one opening is at least 1.15.

The first radius of the at least one flute is preferably in a range from 0.8 mm to 10.0 mm, more preferably in a range from 2.0 mm to 7.0 mm.

The solid shaped body possesses a basic shape of a circular cylinder, wherein the first base area and the second base area are preferably arranged in parallel to each other, especially in case of plane base areas, and/or as mirror images, especially in case of curved or domed base areas. The first base area and the second base area are preferably joined by the lateral area. The lateral area comprises the first number of flutes, such that a circumference of a cross-section of the shaped body is intermitted by the flutes, which can also be referred to as riffles or embossings. The flutes might have rounded edges.

The solid shaped body further comprises the second number of openings, which can also be referred to as holes and which extend through the solid shaped body from the first base area to the second base area. The first number refers to the flutes and the second number refers to the openings. A circumference of the openings in a cross-sectional view is completely surrounded by the shaped body, whereas in contrast thereto, the flutes are solely located at the external circumference of the solid shaped body, being concave parts of the circumference of the solid shaped body.

Preferably, longitudinal axes, more preferable central axes, of the solid shaped body, the flutes and/or the openings, respectively, are arranged in parallel to each other. The term in parallel is understood in that the longitudinal axes, more preferable the central axes, of the solid shaped body, the flutes and/or the openings, respectively, enclose an angle of less than 20°, preferably of less than 10°, more preferably of less than 5° and most preferably of less than 2°.

Preferably, the shaped body comprises 3 to 7 openings. In a first preferred embodiment, the solid shaped body comprises five openings. In a second preferred embodiment, the solid shaped body comprises four openings.

The solid shaped body comprises more openings than flutes. In particular, the difference between the second number of openings and the first number of flutes is exactly 1, such that the solid shaped body comprises one more opening than flutes.

The ratio between the first radius of the at least one flute and the second radius of the at least one opening is preferably in a range from 1.15 to 4.5. In a case, where the second radius is the smallest radius being present at all openings, the ratio between the first radius and the second radius can be in a range from 3.5 to 9.0. In a case, where the second radius is the largest radius being present at all openings, the ratio between the first radius and the second radius is more preferably in a range from 1.3 to 4.5.

Each opening has preferably a circular or elliptic cross-section. The second radius can be the radius of the circular or elliptic cross-section. An elliptic cross-section is characterized by one small radius, in particular one smallest radius, and one large radius, in particular one largest radius, labeled as, in relation to the center of the solid shaped body, radial radius and tangential radius, respectively. The radial radius can be the small radius of the elliptic cross-section and the tangential radius can be the large radius of the elliptic cross-section or vice versa. The term second radius of the at least one opening can refer to the radial radius or the tangential radius of the elliptic cross-section.

Preferably, the second number of openings comprises one central opening and at least one peripheral opening. The second number of openings is preferably the sum of the number of peripheral openings and the central opening. The circumference of the at least one peripheral opening is still completely comprised in the solid shaped body and surrounded by the solid shaped body. The central opening comprises a first center and preferably extends along the central axis of the solid shaped body. In particular, the first center is located on the central axis of the solid shaped body. Center is understood as geometric center. A potential offset between the first center of the central opening and the central axis of the solid shaped body is smaller than an offset between a second center of a peripheral opening and the central axis of the solid shaped body.

Preferably, the peripheral openings are arranged in equidistance to adjacent peripheral openings and in equidistance to the central opening, referring to the centers of the central opening and the peripheral openings, respectively.

Further, the at least one peripheral opening has at least one third radius and the at least one third radius is preferably equal for all of the at least one peripheral openings. The at least one third radius can comprise a radial radius and a tangential radius in case of elliptic peripheral openings. Most preferably, all of the at least one third radii are equal for all of the at least one peripheral openings.

The central opening has a fourth radius and the fourth radius can be smaller or larger than the at least one third radius of the at least one peripheral opening. Preferably, the fourth radius is smaller than the at least one third radius of the at least one peripheral opening. More preferably, the fourth radius is smaller than all of the at least one third radii of all of the at least one peripheral openings.

The fourth radius of the central opening is preferably in a range from 0.5 mm to 8.0 mm, more preferably from 0.6 mm to 2.0 mm.

Preferably, the first number of flutes is equal to the third number of peripheral openings. More preferably, each of the at least one peripheral openings is arranged between two flutes. Correspondingly, the peripheral openings and the flutes are preferably arranged in separate segments of the circular cross-section of the solid shaped body, respectively. The segment, where a peripheral opening, but no flute, is arranged, can also be referred to as lobe. Preferably, one lobe is arranged between two flutes and one flute is arranged between two lobes. Accordingly, flutes and lobes are preferably arranged on the circumference, and thus on the lateral area, of the solid shaped body in an alternating manner.

Preferably, a ratio between a first distance from the first center of the central opening, in particular from the central axis of the solid shaped body, to a second center of the at least one peripheral opening and the diameter of the solid shaped body is in a range from 0.20 to 0.40, more preferably from 0.25 to 0.32. The first distance from the first center of the central opening, in particular from the central axis of the solid shaped body, to the second center of the at least one peripheral opening is preferably in a range from 3.2 to 9.0 mm, more preferably from 3.6 to 6.0 mm.

The central opening preferably has a circular cross-section. The at least one peripheral opening can have an elliptic cross-section. The smaller radius of the ellipse can extend in radial or tangential direction, referring to the solid shaped body. A ratio between the tangential radius to the radial radius of the elliptic cross-section of the at least one peripheral opening is preferably in a range from 0.2 to 1.7, more preferably from 0.3 to 1.6.

The radial radius and the tangential radius of the at least one peripheral opening are preferably in a range from 0.1 mm to 6.0 mm, more preferably from 0.8 mm to 4.0 mm.

Preferably, the solid shaped body comprises at least three flutes. In the first preferred embodiment, where the solid shaped body comprises five openings, the solid shaped body comprises more preferably four flutes. In the second preferred embodiment, where the solid shaped body comprises four openings, the solid shaped body comprises more preferably three flutes. The flutes are preferably arranged in equidistance to adjacent flutes and to the central axis of the solid shaped body.

Preferably, a ratio between the first radius of the at least one flute and the diameter of the solid shaped body is in a range from 0.04 to 0.70, more preferably from 0.10 to 0.50 and most preferably from 0.15 to 0.40. Preferably, all flutes have the same radius, referred to as the first radius.

The flutes have a fictive third center of their cross-sectional area, which can be located outside of the solid shaped body. A ratio between a second distance from the central axis of the solid shaped body to the third center of the at least one flute and the diameter of the solid shaped body is preferably in a range from 0.30 to 1.0, more preferably from 0.45 to 0.80. The second distance between the third center of at least one flute and the central axis of the solid shaped body is preferably in a range from 5.0 mm to 15.0 mm, more preferably from 6.0 mm to 14.5 mm.

Preferably, a ratio between the diameter of the solid shaped body and a height of the solid shaped body is in a range from 0.50 to 2.00, more preferably from 1.00 to 1.70, even more preferably from 1.25 to 1.70. The diameter of the solid shaped body is preferably the maximum diameter of a cross-section of the solid shaped body and the height of the solid shaped body is preferably understood as a maximum distance between the first base area and the second base area, measured perpendicularly to the base areas.

Preferably, the diameter of the solid shaped body is in a range from 10.0 mm to 25.0 mm, more preferably from 12.5 mm to 19.5 mm. The height of the solid shaped body is preferably in a range from 5.0 mm to 17.0 mm, more preferably from 7.5 mm to 15.0 mm.

Further, the lateral area of the solid shaped body can be divided in a straight part and two inclined parts, wherein the straight part is preferably located, for example in form of a belt, between the two inclined parts. A surface of the straight part is more preferably oriented in parallel to the central axis of the solid shape body.

The straight part of the lateral area, which can also be referred to as slit, has a slit length. In this embodiment, a ratio between the slit length and the height of the solid shaped body is preferably up to 0.1. More preferably, the slit length is in a range from 0.01 mm to 1.00 mm, even more preferably from 0.10 mm to 1.00 mm. In particular, the straight part of the lateral surface exhibits the larges diameter of the solid shaped body.

In the case, where inclined parts of the lateral area are present, the inclined parts of the lateral area are preferably inclined from the straight part towards the central axis of the solid shaped body. Preferably, the inclined parts are inclined by an angle, which can also be referred to as pitch angle, in a range from 0.1° to 5.0°, more preferably from 1.0° to 5.0°.

The first base area and/or the second base area of the solid shaped body are preferably domed. More preferably, the first base area and the second base area are domed. In particular, a ratio between a dome height, referring to the first base area and/or the second base area, and the diameter of the solid shaped body is in a range from 0.05 to 0.40, more preferably from 0.05 to 0.25. The dome height is preferably in a range from 0.6 mm to 6.0 mm, more preferably in a range from 0.8 mm to 4.5 mm. The dome is understood as top and bottom part, respectively, of the solid shape body, where its surface is curved in two directions. Correspondingly, the dome, and thus the dome height, ends, where the lateral area is curved in only one direction, which is the radial direction referring to the solid shaped body.

The invention further relates to a use of the solid shaped body as a catalyst, preferably for reforming one or more hydrocarbons to a synthesis gas comprising hydrogen and carbon monoxide, preferably in the presence of carbon dioxide, wherein the hydrocarbons are preferably selected from a group consisting of methane, ethane, propane and butane, wherein the hydrocarbons are more preferably methane.

More preferably, the solid shaped body is used in a method for reforming one or more hydrocarbons, preferably methane, to a synthesis gas comprising hydrogen and carbon monoxide, the method comprising
(a) providing a reactor comprising a reaction zone which comprises the solid shaped body;
(b) passing a reactant gas stream into the reaction zone obtained from (a), wherein the reactant gas stream passed into the reaction zone comprises the one or more hydrocarbons, carbon dioxide, and water; subjecting said reactant gas stream to reforming conditions in said reaction zone; and removing a product stream from said reaction zone, said product stream comprising hydrogen and carbon monoxide.

The solid shaped body preferably comprises a mixed oxide. More preferably, the mixed oxide comprises cobalt or the mixed oxide comprises nickel. Further preferably, the mixed oxide comprises oxygen, aluminum, cobalt and at least one rare earth metal such as lanthanum or the mixed oxide comprises oxygen, aluminum, nickel and at least one alkaline earth metal such as magnesium. In Particular, the at least one rare earth metal is lanthanum. In Particular, the at least one alkaline earth metal is magnesium.

It is preferred that from 50 weight-% to 100 weight-%, more preferably from 60 weight-% to 100 weight-%, even more preferably from 70 weight-% to 100 weight-%, further preferably from 80 weight-% to 100 weight-%, in particular from 90 weight-% to 100 weight-%, in particular preferably from 95 weight-% to 100 weight-%, most preferably from 99 weight-% to 100 weight-% of the solid shaped body consist of the mixed oxide and optionally at least one suitable binder. From 99 weight-% to 100 weight-%, even more preferably from 99.5 weight-% to 100 weight-%, most preferably from 99.9 weight-% to 100 weight-% of the solid shaped body can also consist of the mixed oxide.

In the case, where the mixed oxide comprises nickel, the mixed oxide preferably comprises at least nickel-magnesium mixed oxide and magnesium spinel and optionally aluminum oxide hydroxide. The nickel-magnesium mixed oxide has preferably an average crystallite size of ≤100 nm, more preferably ≤70 nm, even more preferably ≤50 nm. The magnesium spinel phase has preferably an average crystallite size of 100 nm, more preferably ≤70 nm, even more preferably ≤50 nm. The proportion of nickel in the mixed oxide is preferably in the region of 30 mol-%, more preferably in a range from 6 mol-% to 30 mol-%, the proportion of magnesium is preferably in the range of 8 mol-% to 38 mol-%, more preferably 23 mol-% to 35 mol-%, and the proportion of aluminum is preferably in the range of 50 mol-% to 70 mol-%. The intensity of the diffraction reflection of the mixed oxide at 43.09° 2θ is preferably less than or equal to the intensity of the diffraction reflection at 44.82° 2θ, with the intensity of the diffraction reflection at 43.08° 2θ more preferably being less than the intensity of the reflection at 44.72° 2θ.

The solid shaped body can be produced for example as described in EP 3 574 994 A1, especially when the solid shaped body comprises the mixed oxide comprising nickel.

In the case, where the mixed oxide comprises cobalt, a weight ratio of cobalt relative to aluminum, calculated as elements, is preferably at least 0.17:1 in the mixed oxide.

As regards the contents of cobalt, lanthanum and aluminum in the mixed oxide comprised in the solid shaped body, no particular restriction applies. It is preferred that from 6 weight-% to 9 weight-%, more preferably from 6.5 weight-% to 8.5 weight-%, most preferably from 7 weight-% % to 8 weight-% of the mixed oxide consist of cobalt, calculated as element. Further, it is preferred that from 15 weight-% to 20 weight-%, more preferably from 16 weight-% to 19 weight-%, most preferably from 17 weight-% to 18 weight-%, in particular from 17.5 weight-% to 17.8 weight-% of the mixed oxide consist of lanthanum, calculated as element. Further, it is preferred that from 33 weight-% to 40 weight-%, more preferably from 34 weight-% to 38 weight-%, most preferably from 35 weight-% to 37 weight-%, in particular from 35.5 weight-% to 36.5 weight-% of the mixed oxide consist of aluminum, calculated as element.

The mixed oxide comprising cobalt may comprise an amorphous phase, one or more crystalline phases, or an amorphous phase and one or more crystalline phases. It is preferred that the mixed oxide comprises one or more crystalline phases, more preferably at least two crystalline phases, most preferably at least three crystalline phases. It is preferred that from 80 weight-% to 100 weight-% of the mixed oxide are in crystalline form, more preferably from 90 weight-% to 100 weight-%, most preferably from 92 weight-% to 100 weight-%.

Further, it is preferred that the mixed oxide comprises one or more of a crystalline phase of LaCoAl₁₁O₁₉ and a crystalline phase of LaAl(Co)O₃. In the case where the mixed oxide comprises a crystalline phase of LaCoAl₁₁O₁₉ and a crystalline phase of LaAl(Co)O₃, it is preferred that the weight ratio of LaCoAl₁₁O₁₉ relative to LaAl(Co)O₃ is in a range of from 5:1 to 30:1, more preferably in a range of from 10:1 to 25:1, most preferably in a range of from 12:1 to 22:1, in particular in a range of from 13:1 to 20:1, for example in a range of from 13:1 to 15:1, determined via XRD. It is particularly preferred that the mixed oxide comprises a further crystalline phase La(OH)₃. Further, it is particularly preferred that the mixed oxide comprises a further crystalline phase LaAlO₃.

Further, it is preferred that the mixed oxide comprises a further crystalline phase CoAl₂O₄. In the case where the mixed oxide comprises at least a crystalline phase of LaCoAl₁₁O₁₉ and a crystalline phase CoAl₂O₄, it is preferred that a weight ratio of LaCoAl₁₁O₁₉ relative to CoAl₂O₄ in the mixed oxide is in a range of from 8:1 to 35:1, more preferably in a range of from 10:1 to 30:1, further preferably in a range of from 12:1 to 30:1, in particular in a range of from 15:1 to 27:1, most preferably in a range of from 17:1 to 25:1, for example in a range of from 20:1 to 22:1.

It is preferred that the solid shaped body is a calcined solid shaped body. It is more preferred that the solid shaped body is a calcined solid shaped body, wherein the calcination has been performed in a first alternative in a gas atmosphere having a temperature in a range of from 350° C. to 450° C., preferably in a range of from 390° C. to 410° C. Further, it is preferred that the gas atmosphere comprises oxygen, more preferably is one or more of oxygen, air, or lean air. Preferably, the calcining is performed for 2 h to 10 h.

It is more preferred in a second alternative that the solid shaped body is a calcined solid shaped body, wherein the calcination has been performed in a gas atmosphere having a temperature in a range of from 1100° C. to 1400° C., more preferably in a range of from 1175° C. to 1225° C., wherein the gas atmosphere preferably comprises oxygen, more preferably is one or more of oxygen, air, or lean air. Preferably, the calcining is performed for 2 h to 10 h.

The solid shaped body can be produced for example by a process comprising:
(i) preparing a mixture comprising a lanthanum salt, a cobalt salt, an oxidic aluminum compound, and an acid, wherein one or more of the lanthanum salt and the cobalt salt, preferably both the lanthanum salt and the cobalt salt, are not a nitrate;
(ii) preparing a solid shaped body from the mixture obtained from (i), comprising
   (ii.1) subjecting the mixture obtained from (i) to a shaping process, obtaining a first solid shaped body;
   (ii.2) preferably drying the first solid shaped body obtained from (ii.1) in a gas atmosphere;
   (ii.3) calcining the first solid shaped body obtained from (ii.1) or (ii.2), preferably from (ii.2), in a gas atmosphere having a temperature in a range of from 350° C. to 470° C.;
(iii) preferably subjecting the calcined first solid shaped body obtained from (ii) to a reshaping process, obtaining a second solid shaped body having a geometry different from the geometry of the first solid shaped body;
(iv) calcining the solid shaped body obtained from (ii) or (iii), preferably from (iii), in a gas atmosphere having a temperature in a range of from 1100° C. to 1400° C., obtaining the solid shaped body comprising the mixed oxide.

It is preferred that preparing the mixture according to (i) comprises kneading the mixture.

Further, it is preferred that subjecting the mixture obtained from (i) to a shaping process according to (ii.1) comprises, more preferably consists of extruding, when the reshaping process in (iii) is performed.

According to a first alternative as regards the drying according to (ii.2), it is preferred that the first solid shaped body is dried in a gas atmosphere, the gas atmosphere preferably having a temperature in a range of from 50° C. to 150° C., more preferably in a range of from 80° C. to 110° C., wherein the gas atmosphere preferably comprises oxygen, more preferably is one or more of oxygen, air, or lean air, wherein the drying according to (ii.2) is performed preferably for 5 h to 25 h.

According to a second alternative as concerns the drying according to (ii.2), it is preferred that the first solid shaped body is dried in a gas atmosphere, the gas atmosphere preferably having a temperature in a range of from 80° C. to 150° C., more preferably in a range of from 90° C. to 140° C., wherein the gas atmosphere preferably comprises oxygen, more preferably is one or more of oxygen, air, or lean air, wherein the drying according to (ii.2) is performed preferably for 0.2 h to 2 h, wherein drying is preferably conducted using a belt dryer.

According to a first alternative as regards the calcining according to (ii.3), it is preferred that the first solid shaped body is calcined in a gas atmosphere having a temperature in a range of from 350° C. to 450° C., more preferably in a range of from 390° C. to 410° C. Further, it is preferred that the gas atmosphere comprises oxygen, more preferably is one or more of oxygen, air, or lean air. Further, the calcining according to (ii.3) is performed preferably for 2 h to 10 h.

According to a second alternative as regards the calcining according to (ii.3), it is preferred that the first solid shaped body is calcined according to (ii.3) in a rotary kiln in a gas atmosphere having a temperature in a range of from 350° C. to 450° C., more preferably in a range of from 390° C. to 410° C. Further, it is preferred that the gas atmosphere comprises oxygen, more preferably is one or more of oxygen, air, or lean air. In the case where the first solid shaped body is calcined according to (ii.3) as disclosed herein, it is preferred that calcining comprises separating carbon dioxide from the gas stream, more preferably with a carbon dioxide washer.

As regards the re-shaping according to (iii), it is preferred that re-shaping according to (iii) comprises crushing the calcined solid shaped body obtained from (ii) and subjecting the obtained crushed material to a re-shaping process, obtaining the second solid shaped body, wherein crushing is more preferably conducted by milling.

In the case where re-shaping comprises crushing the calcined solid shaped body obtained from (ii) and subjecting the obtained crushed material to a re-shaping process for obtaining the second solid shaped body, it is particularly preferred that after crushing the calcined solid shaped body obtained from (ii) and prior to subjecting the obtained crushed material to the re-shaping process according to (iii), the process further comprises preparing a mixture comprising the crushed material and one or more binders, more preferably one or more of graphite, a polysaccharide, a sugar alcohol and a synthetic polymer, even more preferably one or more of graphite, a sugar alcohol, a synthetic polymer, cellulose, a modified cellulose and a starch, most preferably graphite, a sugar alcohol, a synthetic polymer, a microcrystalline cellulose, a cellulose ether, more preferably graphite, sorbitol, mannitol, polyethylene glycol (PEG), polyvinylpyrrolidone (PVP), hydroxypropyl cellulose (HPC) and hydroxypropyl methylcellulose (HPMC). In this regard, it is preferred according to a first alternative that in the mixture, a weight ratio of the one or more binders relative to the crushed material is preferably in a range of from 1:10 to 1:20, more preferably in a range of from 1:12 to 1:18, even more preferably in a range of from 1:13 to 1:17. According to a second alternative, it is preferred that in the mixture, a weight of the one or more binders calculated with respect to a total weight of the mixture is in a range of from 0.5 weight-% to 10 weight-%, more preferably in a range of from 2 weight-% to 9 weight-%, even more preferably in a range of from 4 weight-% to 8 weight-%, most preferably in a range of from 5 weight-% to 7 weight-%.

Further in the case where re-shaping comprises crushing the calcined solid shaped body obtained from (ii) and subjecting the obtained crushed material to a re-shaping process for obtaining the second solid shaped body, it is preferred that after crushing the calcined solid shaped body obtained from (ii) and prior to the re-shaping process according to (iii), the process further comprises separating the particles of the crushed material according to their size into two or more fractions. Preferably, the fractions of the particles with the smallest size, preferably the fraction of the particles with the smallest size, are/is subjected to the re-shaping process. Preferably, the particles with the smallest size have a maximum diameter of 2.0 mm, more preferably a maximum diameter of 1.5 mm, even more preferably a maximum diameter of 1.0 mm. Fractions with even smaller maximum sizes, such as 0.75 mm or 0.5 mm, are generally conceivable.

In the case where a fraction or fractions of particles which do not have the smallest size is/are separated, it is particularly preferred to crush said fraction or fractions again to separate the fractions of the particles with the smallest size, preferably the fraction of the particles with the smallest size, for subjecting to the re-shaping process according to (iii). In accordance with the above, it is preferred that the particles with the smallest size have a maximum diameter of 2.0 mm, more preferably a maximum diameter of 1.5 mm, even more preferably a maximum diameter of 1.0 mm, whereby fractions with even smaller maximum sizes, such as 0.75 mm or 0.5 mm, are also conceivable.

In the case where re-shaping comprises crushing the calcined solid shaped body obtained from (ii) and subjecting the obtained crushed material to a re-shaping process for obtaining the second solid shaped body, wherein prior to the re-shaping process according to (iii), the process further comprises separating the particles of the crushed material according to their size into two or more fractions, it is preferred that the process further comprises recycling at least a portion of the particles of the fraction or fractions which do not have the smallest size to step (i) of the process, comprising preparing the mixture according to (i) comprising the lanthanum salt, the cobalt salt, the oxidic aluminum compound, the acid, more preferably water, and at least the portion of said fractions.

Further, it is particularly preferred that from 65 weight-% to 95 weight-%, more preferably from 75 weight-% to 95 weight-%, even more preferably from 85 weight-% to 95 weight-% of the mixture prepared in (i) consist of the lanthanum salt, the cobalt salt, the oxidic aluminum compound, the acid, and more preferably water, and from 5 weight-% to 35 weight-%, more preferably from 5 weight-% to 25 weight-%, even more preferably from 5 weight-% to 15 weight-% of the mixture consist of said fractions.

It is particularly preferred that the particles of the fraction or fractions which do not have the smallest size are re-agglomerated, preferably by compaction. More preferably, the obtained reagglomerated particles are recycled in the re-shaping according to (iii). As a first alternative, the obtained re-agglomerated particles are recycled in the re-shaping according to (iii) alone, thus, as calcined first solid shaped body obtained from (ii). As a second alternative, the obtained reagglomerated particles are recycled in the re-shaping according to (iii) together with the calcined first solid shaped body obtained from (ii).

Further, it is preferred that the re-shaping process according to (iii) comprises, more preferably consists of tableting.

As regards calcining the solid shaped body obtained from (ii) or (iii) according to (iv), it is preferred that (iv) comprises drying the solid shaped body obtained from (ii) or (iii), more preferably from (iii), prior to calcining, in a gas atmosphere having a temperature in a range of from 50° C. to 250° C., more preferably in a range of from 80° C. to 100° C., wherein the gas atmosphere preferably comprises oxygen, more preferably is one or more of oxygen, air, or lean air, wherein the drying is performed more preferably for 5 h to 22 h.

As regards calcining the second solid shaped body according to (iv), it is preferred that the second solid shaped body is calcined in a gas atmosphere having a temperature in a range of from 1125° C. to 1275° C., more preferably in a range of from 1175° C. to 1225° C., wherein the gas atmosphere more preferably comprises oxygen, more preferably is one or more of oxygen, air, or lean air, wherein the calcining according to (iv) is performed more preferably for 2 h to 10 h. Moreover, it is preferred that the process for producing the solid shaped body consists of steps (i), (ii), (iii) and (iv), (iv) preferably comprising the drying as described above. In this regard, it is preferred that (i) is more preferably carried out prior to (ii), wherein (ii) is more preferably carried out prior to (iii), wherein (iii) is more preferably carried out prior to (iv), wherein (ii) is more preferably carried out after (i), wherein (iii) is more preferably carried out after (ii), wherein (iv) is more preferably carried out after (iii).

### BRIEF DESCRIPTION OF THE DRAWINGS

The present invention is described in more detail at hand of the accompanying drawings, in which:

FIG. 1 shows a longitudinal section of a solid shaped body with a cylindrical form,

FIG. 2 shows a cross-section of a solid shaped body with a cylindrical form comprising openings and flutes,

FIGS. 3 to 5 show test set-ups for determination of side crushing strength,

FIGS. 6 and 7 show a perspective view and a cross-section, respectively, of a solid shaped body according to the state of the art,

FIG. 8 shows a perspective view of a further solid shaped body according to the state of the art,

FIG. 9 shows a side view of a solid shaped body of a first embodiment of a solid shaped body with a cylindrical form comprising four flutes and five openings,

FIG. 10 shows a top view of a solid shaped body of a first embodiment with a cylindrical form comprising four flutes and five openings,

FIGS. 11 to 14 show solid shaped bodies of the first embodiment with a cylindrical form comprising four flutes and five openings and

FIGS. 15 to 17 show solid shaped bodies of a second embodiment with a cylindrical form comprising three flutes and four openings.

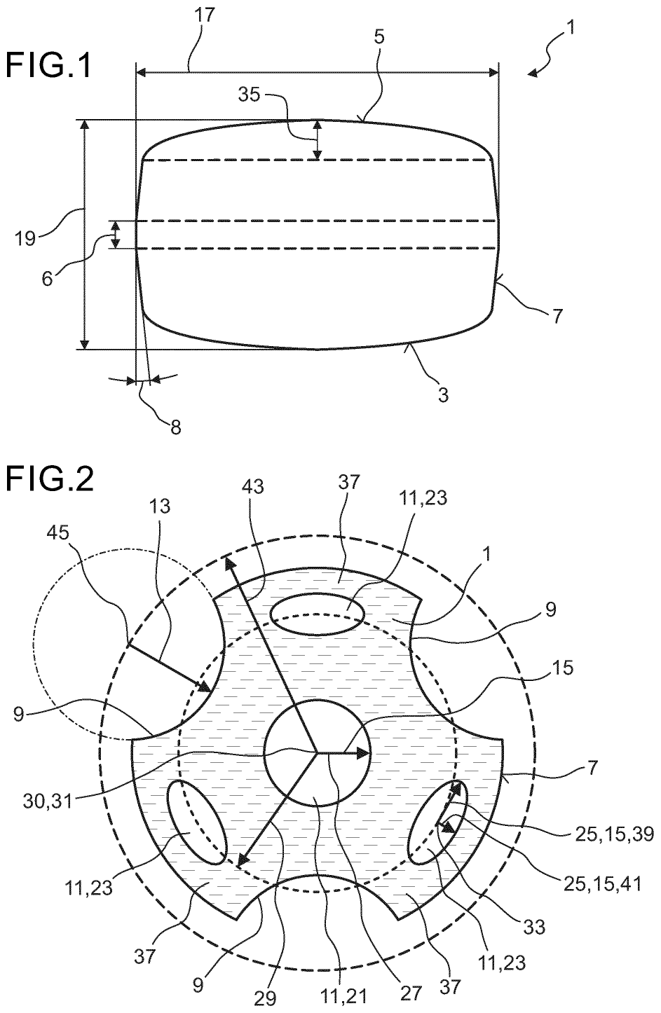

FIG. 1 shows a longitudinal section of a solid shaped body 1 having a cylindrical form. The solid shaped body 1 comprises a first base area 3 and a second base area 5, which are connected by a lateral area 7. The lateral area 7 comprises a slit 6 and a pitch angle 8. In the illustrative embodiment of FIG. 1, the first base area 3 and the second base area 5 are domed with a dome height 35. The solid shaped body 1 has a height 19 and a diameter 17.

FIG. 2 shows a cross-section of a solid shaped body 1 having a cylindrical form and comprising three flutes 9 and four openings 11. The flutes 9 are located at the lateral surface 7 of the solid shaped body 1. Further, the flutes 9 and the openings 11 extend from the first base area 3 to the second base area 5 of the solid shaped body 1. The flutes 9 are arranged in equidistance to each other and have a first radius 13, which is larger than a second radius 15 of at least one opening 11.

The four openings 11 comprise one central opening 21 and three peripheral openings 23. Each peripheral opening 23 is arranged between two flutes 9 and vice versa. Two adjacent flutes 9 are separated from each other by a lobe 37. Thus, the solid shaped body 1 according to FIG. 2 comprises three lobes 37.

Each peripheral opening 23 is located in one of the lobes 37. The peripheral openings 23 have elliptic cross-sections and therefore two third radii 25. In the illustrative embodiment of FIG. 2, a tangential radius 39 is larger than a radial radius 41.

The central opening 21 has a fourth radius 27. Further, the central opening 21 has a first center 31, being located on a central axis 30 of the solid shaped body 1, and the peripheral openings 23 have second centers 33. A first distance 29 between the first center 31 of the solid shaped body 1 and the second center 33 of the peripheral openings 23 is represented as radius of a circle, on which the second centers 33 of the peripheral openings 23 are located.

In addition, a second distance 43 from the first center 31 of the central opening 21 to a third center 45 of flutes 9 is represented as radius of a circle, on which the third centers 45 of flutes 9 are located. Each third center 45 refers to a fictive circle, an arc of which is forming one of the flutes 9.

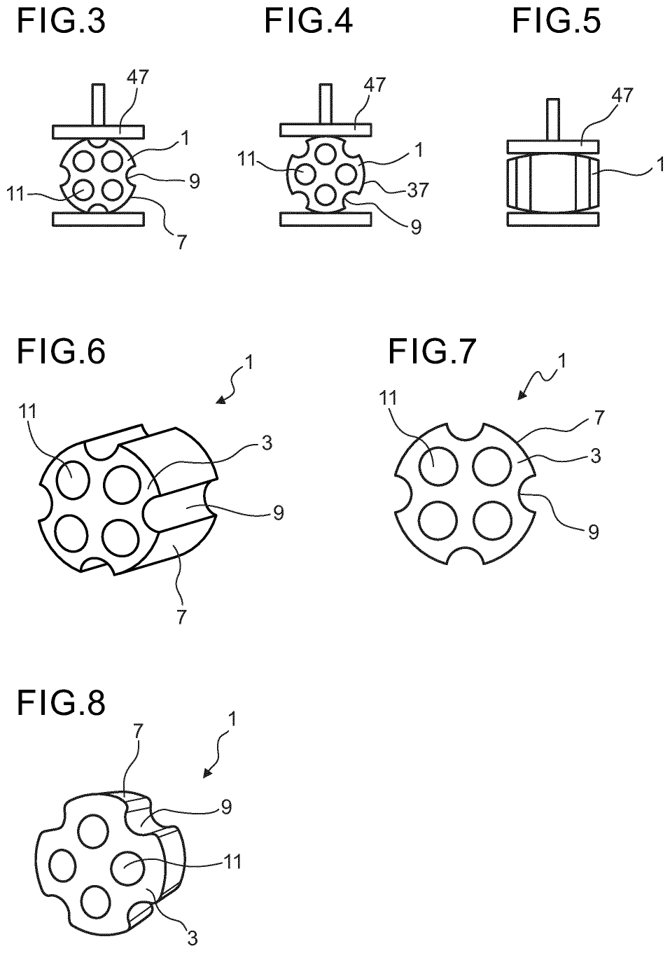

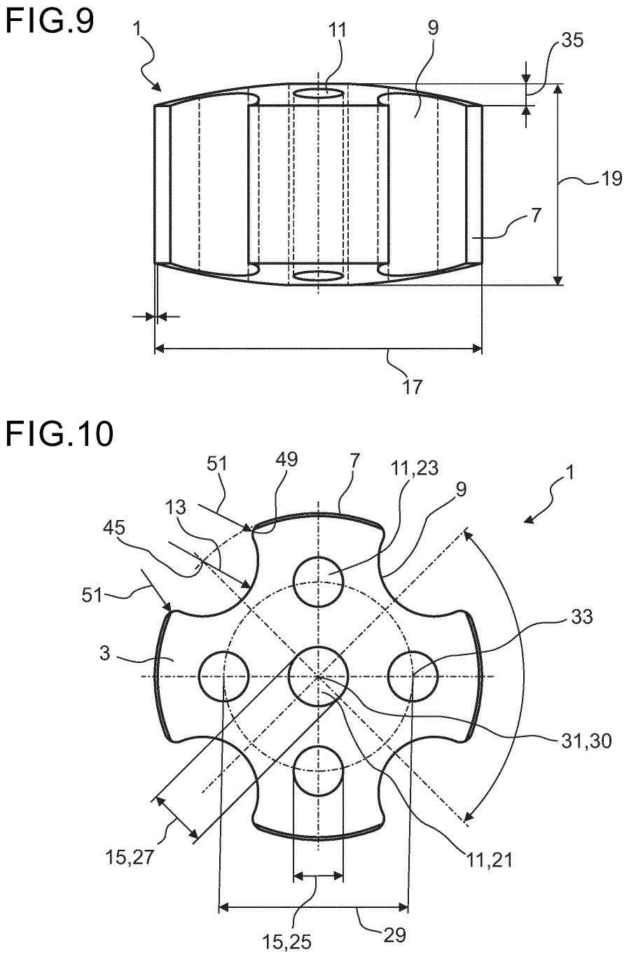

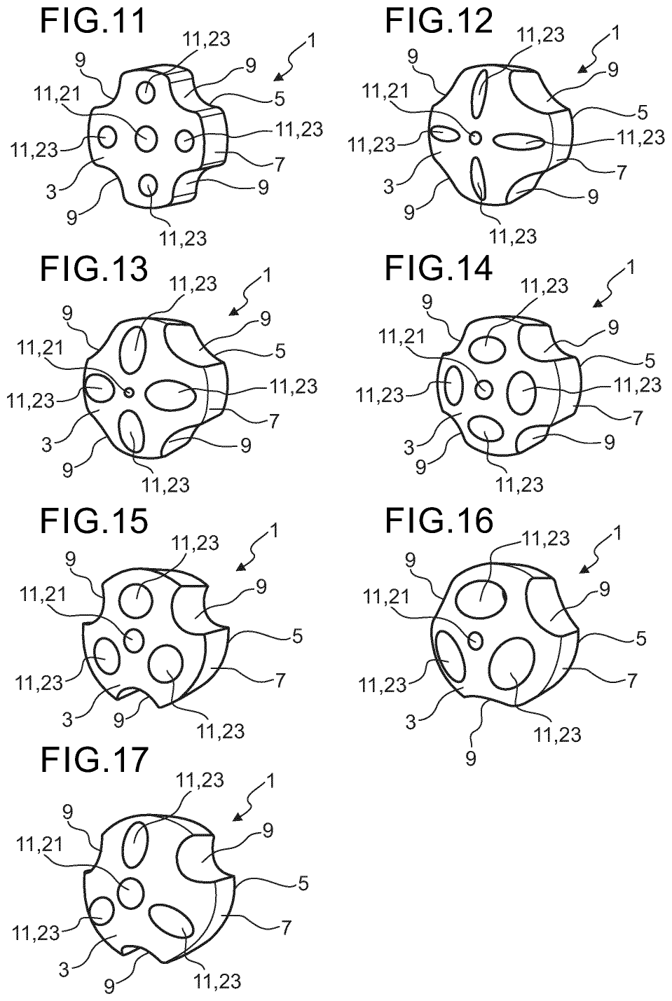

FIGS. 3 to 5 show three different test set-ups for determination of side crushing strength (SCS) of a solid shaped body 1 with three different positions of the solid shaped body 1 in a testing machine 47. According to FIG. 3 determination of a side crushing strength A is represented. Here, the sample solid shaped body 1 is in a test position standing on the flutes 9, which are aligned vertically. FIG. 4 illustrates determination of a side crushing strength B, wherein the sample solid shaped body 1 stands on the lobes 37 and is turn by 45° or 60° compared the set-up shown in FIG. 3. In case of an odd number of lobes the side crushing strength B corresponds to the side crushing strength A as each lobe is opposing one flute. According to FIG. 5, a side crushing strength C is determined and refers to a position where openings 11 of the solid shaped body 1 are orientated in parallel to the direction of the force applied on the sample solid shaped body 1 during the test by the testing machine 47.

FIG. 6 shows a perspective view of a solid shaped body 1 according to the state of the art and FIG. 7 shows a cross-section of the solid shaped body 1 according to FIG. 6. The solid shaped body 1 comprises four flutes 9 and four openings 11 extending from a first base area 3 through the solid shaped body 1.

FIG. 8 shows a perspective view of a further solid shaped body 1 according to the state of the art, which also comprises the same number of flutes 9 as openings 11.

FIGS. 9 to 14 show solid shaped bodies 1 of a first embodiment comprising four flutes 9 and five openings 11, of which one opening 11 is a central opening 21 and three openings 11 are peripheral openings 23.

FIG. 9 shows a side view of a solid shaped body 1 and FIG. 10 shows a top view of a solid shaped body 1 according to the first embodiment with a cylindrical form comprising four flutes 9 and five openings 11, respectively.

The solid shaped body 1 according to FIG. 10 has a diameter 17 of 16.5 mm and a height of 19 of 10 mm. The flutes 9 are characterized by a first radius 13 of 2.825 mm. In addition, each flute 9 possesses edges 49, which are rounded by an edge radius 51 of 0.8 mm. Further, the peripheral openings 23 have a third radius 25 of 1.25 mm, the central opening 21 has a fourth radius 27 of 1.5 mm and a first distance 29 between a first center 31 of the central opening 21 and second centers 33 of the peripheral openings 23 accounts to 4.9 mm. Two lines connecting the third centers 45 of two adjacent flutes 9 with the first center 31 of the central opening 21, respectively, enclose a flute angle 53 of 90°.

The solid shaped body 1 according to FIG. 11 corresponds to the solid shaped body 1 shown in FIG. 10. All openings 11 have a circular cross-section. First radii 13 of flutes 9 are larger than all second radii 15 of all openings 11. All peripheral openings 23 have only one third radius 25, which is equal for all peripheral openings 23 and smaller than a fourth radius 27 of the central opening 21.

In FIGS. 12 to 14, the peripheral openings 23 have an elliptic cross-section, wherein according to FIGS. 12 and 13, a tangential radius 39 is smaller than a radial radius 41.

According to FIGS. 12 and 13, the radial radius 41 is larger than the fourth radius 27 of the central opening 21. The fourth radius 27 of the central opening 21 is also smaller than the tangential radius 39 of the peripheral openings 23.

In contrast to FIGS. 12 and 13, the radial radius 41 is smaller than the tangential radius 39 according to the solid shaped body 1 shown in FIG. 14.

In FIGS. 15 to 17, solid shaped bodies 1 are represented possessing three flutes 9, three peripheral openings 23 and one central opening 21.

According to FIG. 15, all openings 11 have a circular cross-section. Third radii 25 of the peripheral openings 23 are larger than the fourth radius 27 of the central opening 21.

The peripheral openings 23 according to FIGS. 16 and 17 have elliptic cross-sections. In FIG. 16, the tangential radius 39 is larger than the radial radius 41 and according to FIG. 17, the radial radius 41 is larger than the tangential radius 39 of the peripheral openings 23. Further, the fourth radius 27 of the central opening 21 is smaller than all third radii 25 of the peripheral openings 23.

### Examples and Comparative Examples

Dimensions of solid shaped bodies according to comparative examples 1.1, 1.2, 1.2.1 and 1.2.2 are summarized in table 1. The given reference numerals refer to FIGS. 1 and 2, respectively.

TABLE 1

| | Reference | | Comparative example No. | | | |
|---|---|---|---|---|---|---|
| | numeral | Unit | 1.1 | 1.2 | 1.2.1 | 1.2.2 |
| Diameter | 17 | mm | 13.00 | 16.50 | 14.03 | 12.87 |
| Second radius | 15 | mm | 0.00 | 0.00 | | |
| Height | 19 | mm | 17.00 | 10.00 | 8.50 | 7.80 |
| Dome height | 35 | mm | 1.10 | 1.10 | | |
| First radius | 13 | mm | 1.50 | 2.05 | | |
| Second distance | 43 | mm | 6.50 | 8.25 | | |
| First distance | 29 | mm | 3.40 | 4.10 | | |
| Tangential radius | 39 | mm | 1.65 | 1.90 | | |
| Radial radius | 41 | mm | 1.65 | 1.90 | | |
| First number | — | — | 4 | 4 | | |

Dimensions of solid shaped bodies according to examples 2.1 to 2.4 and 3.1 to 3.3, as illustrated in FIGS. 11 to 17, are summarized in tables 2 and 3.

TABLE 2

| | Reference | | | | | | | |
|---|---|---|---|---|---|---|---|---|
| | numeral | Unit | 2.1 | 2.1.1 | 2.1.2 | 2.2 | 2.3 | 2.4 |
| Diameter | 17 | mm | 16.50 | 14.03 | 12.87 | 18.06 | 18.02 | 17.13 |
| Second | 15 | mm | 1.50 | | | 0.75 | 0.67 | 1.12 |
| radius | | | | | | | | |
| Height | 19 | mm | 10.00 | 8.50 | 7.80 | 13.07 | 13.37 | 12.45 |
| Dome | 35 | mm | 1.10 | | | 3.64 | 3.13 | 2.56 |
| height | | | | | | | | |
| First | 13 | mm | 2.83 | | | 5.78 | 5.78 | 3.25 |
| radius | | | | | | | | |
| Second | 43 | mm | 8.25 | | | 12.30 | 12.93 | 9.81 |
| distance | | | | | | | | |
| First | 29 | mm | 4.90 | | | 5.16 | 5.08 | 4.73 |
| distance | | | | | | | | |
| Tangential | 39 | mm | 1.25 | | | 0.88 | 1.77 | 2.46 |
| radius | | | | | | | | |
| Radial | 41 | mm | 1.25 | | | 2.86 | 2.86 | 1.59 |
| radius | | | | | | | | |
| First | — | — | 4 | 4 | 4 | 4 | 4 | 4 |
| number | | | | | | | | |
| Slit | 6 | mm | 0 | 0 | 0 | 0 | 0 | 0 |
| Pitch | 8 | ° | 0 | 0 | 0 | 0 | 0 | 0 |
| angle | | | | | | | | |

TABLE 3

| | Reference | | | | | | |
|---|---|---|---|---|---|---|---|
| | numeral | Unit | 3.1 | 3.2 | 3.2.1 | 3.2.2 | 3.3 |
| Diameter | 17 | mm | 18.24 | 18.81 | 15.99 | 14.67 | 19.17 |
| Second radius | 15 | mm | 1.49 | 1.06 | | | 1.83 |
| Height | 19 | mm | 11.39 | 14.74 | 12.53 | 11.50 | 14.11 |
| Dome height | 35 | mm | 1.21 | 4.40 | | | 3.67 |
| First radius | 13 | mm | 3.38 | 6.97 | | | 3.14 |
| Second distance | 43 | mm | 9.61 | 14.30 | | | 9.85 |
| First distance | 29 | mm | 5.01 | 5.01 | | | 5.80 |
| Tangential radius | 39 | mm | 2.49 | 3.53 | | | 1.64 |
| Radial radius | 41 | mm | 2.13 | 2.23 | | | 2.77 |
| First number | — | — | 3 | 3 | 3 | 3 | 3 |
| Slit | 6 | mm | 0 | 0 | 0 | 0 | 0 |
| Pitch angle | 8 | ° | 0 | 0 | 0 | 0 | 0 |

For all examples and comparative examples the surface, volume and relative weight of the respective solid shaped body were calculated and are summarized in table 4. The volume indicates the volume, which is filled with material, thus the total outer volume of the solid shaped body subtracting an inner volume of the openings and flutes.

The geometric surface and geometric volume of each solid shaped body were determined from CFD (Computational Fluid Dynamics) simulations based on CAD (Computer Aided Design) models of each solid shaped body geometry.

TABLE 4

| Nb. | Surface (m²) | Volume (m³) | Relative weight |
|---|---|---|---|
| 1.1 | 1.53 · 10⁻³ | 1.36 · 10⁻⁶ | 1.07 |
| 1.2 | 1.19 · 10⁻³ | 1.26 · 10⁻⁶ | 1.00 |
| 1.2.1 | 0.86 · 10⁻³ | 0.80 · 10⁻⁶ | 0.63 |
| 1.2.2 | 0.72 · 10⁻³ | 0.62 · 10⁻⁶ | 0.49 |
| 2.1 | 1.13 · 10⁻³ | 1.25 · 10⁻⁶ | 0.99 |
| 2.1.1 | 0.82 · 10⁻³ | 0.77 · 10⁻⁶ | 0.61 |
| 2.1.2 | 0.69 · 10⁻³ | 0.59 · 10⁻⁶ | 0.47 |
| 2.2 | 1.52 · 10⁻³ | 1.86 · 10⁻⁶ | 1.47 |
| 2.3 | 1.57 · 10⁻³ | 1.94 · 10⁻⁶ | 1.54 |
| 2.4 | 1.50 · 10⁻³ | 1.58 · 10⁻⁶ | 1.25 |
| 3.1 | 1.52 · 10⁻³ | 1.74 · 10⁻⁶ | 1.38 |
| 3.2 | 1.71 · 10⁻³ | 1.95 · 10⁻⁶ | 1.55 |
| 3.2.1 | 1.24 · 10⁻³ | 1.20 · 10⁻⁶ | 0.95 |
| 3.2.2 | 1.04 · 10⁻³ | 0.93 · 10⁻⁶ | 0.73 |
| 3.3 | 1.72 · 10⁻³ | 2.31 · 10⁻⁶ | 1.83 |

Resulting properties of the solid shaped bodies are summarized in table 5, which represent calculated values.

The pressure drop for each solid shaped body geometry was calculated via numerical flow simulation, which describes the flow in spaces between solid shaped bodies of a bed of solid shaped bodies. The procedure comprised three consecutive steps. First, a CAD model of each solid shaped body was created. A tube with an internal diameter of a typical technical reactor of ca. 100 mm was assumed as an outer container comprising the bed of the solid shaped bodies. Both, the digital container geometry and the digital geometry of the solid shaped body, were fed into a simulation program which allowed to calculate the arrangement of the solid shaped bodies as filled into the container, using Newton's equations of motion.

Pressure drop calculations were performed with air at ambient temperature and at a superficial velocity of 1 m/s in a DN100 tube. Literature values for air at a constant operating pressure of 1 bar and a temperature of 20° C. were used for the thermodynamic and transport properties of the gas.

In order to calculate the side crush strength (SCS), also referred to as crushing strength, of each solid shaped body, a numerical method such as Finite Element Analysis was used to simulate a side crush strength test applying each CAD model of the solid shaped bodies, based on alumina.

For the minimum SCS per particle volume, the lowest of the determined crushing strengths was divided by the volume of the solid shaped body. The axial dispersion coefficient was calculated according to Levenspiel, The Chemical Reactor Omnibook, 4. Edition, Chapter 64, 1993 using “Small Deviation from Plug Flow”, wherein for an ideal plug flow reactor Dₐₓ→0.

TABLE 5

| | Crushing | Crushing | Minimum | Relative | | Specific | Axial |
|---|---|---|---|---|---|---|---|
| | strength | strength | SCS/particle | packed | Pressure | surface | dispersion |
| | A | B | volume | bed | drop | area | coefficient |
| Nb. | (N) | (N) | (N/m³) | density | (Pa/m) | (m²/m³) | (m²/s) |
| 1.1 | 389 | 174 | 1.28 · 10⁺⁸ | 0.94 | 851 | 423 | 1.55 · 10⁻² |
| 1.2 | 301 | 139 | 1.10 · 10⁺⁸ | 1.00 | 816 | 371 | 1.18 · 10⁻² |
| 1.2.1 | 228 | 105 | 1.31 · 10⁺⁸ | 1.02 | 949 | 452 | 1.02 · 10⁻² |
| 1.2.2 | 204 | 96 | 1.56 · 10⁺⁸ | 1.01 | 975 | 486 | 1.23 · 10⁻² |
| 2.1 | 261 | 266 | 2.09 · 10⁺⁸ | 1.02 | 822 | 374 | 1.16 · 10⁻² |
| 2.1.1 | 206 | 216 | 2.68 · 10⁺⁸ | 1.03 | 1040 | 452 | 1.02 · 10⁻² |
| 2.1.2 | 173 | 185 | 2.91 · 10⁺⁸ | 1.03 | 1191 | 491 | 1.02 · 10⁻² |
| 2.2 | 228 | 338 | 1.23 · 10⁺⁸ | 1.05 | 762 | 352 | 1.45 · 10⁻² |
| 2.3 | 346 | 228 | 1.18 · 10⁺⁸ | 0.91 | 581 | 343 | 1.61 · 10⁻² |
| 2.4 | 225 | 225 | 1.43 · 10⁺⁸ | 0.93 | 653 | 364 | 1.50 · 10⁻² |
| 3.1 | 344 | — | 1.98 · 10⁺⁸ | 0.92 | 600 | 328 | 1.51 · 10⁻² |
| 3.2 | 134 | — | 6.86 · 10⁺⁷ | 0.88 | 460 | 315 | 1.83 · 10⁻² |
| 3.2.1. | 106 | — | 8.83 · 10⁺⁷ | 0.89 | 641 | 374 | 1.69 · 10⁻² |
| 3.2.2 | 90 | — | 9.70 · 10⁺⁷ | 0.90 | 717 | 413 | 1.60 · 10⁻² |
| 3.3 | 146 | — | 6.33 · 10⁺⁷ | 0.92 | 856 | 381 | 1.21 · 10⁻² |

Results according to table 5, which were derived from the modeled solid shaped bodies, show that the crushing strength B was improved at least over the comparative example of solid shaped body 1.2. The geometric form of example 2.1 led to an increased minimum crushing strength (SCS) per particle volume over the comparative example while maintaining a comparable pressure drop. For other examples such as 3.2 the pressure drop was significantly decreased and/or the axial dispersion coefficient was enhanced. Example 3.3 showed an improved specific surface area over comparative example 1.2.

Resulting properties of the solid shaped bodies were further studied at hand of 3D-printed representative solid shaped bodies prepared from CaSO₄.

The 3D-printed solid shaped bodies were manufactured with a 3D-printer using a Z Corporation Spectrum Z510 model. The solid shaped bodies of a constant composition, also referred to as tablets, were made of a mixture comprising gypsum (CaSO₄) using commercial VisiJet PXL Core by 4Dconcepts and a binder using commercial VisiJet PXL Binder by 4Dconcepts. During the 3D-printing process individual solid shaped bodies were not in contact with neighboring solid shaped bodies and all shaped bodies were oriented in such a way that the openings of the solid shaped bodies extended vertically through the shaped bodies. 3D-printing was carried out with a 3D-printing layer thickness of 0.1 mm. Typically, around 200 layers were applied to complete one solid shaped body and around 100 solid shaped bodies were 3D-printed in one experiment. After completing the 3D-printing process, the printed solid shaped bodies were allowed to stay for 1 h in the printing chamber and the build envelope, respectively. Afterwards the solid shaped bodies were removed individually by hand and cleaned from residual powder.

The 3D-printed solid shaped bodies were analyzed according to the following measurement methods. Results of the measurements are summarized in table 6. For comparative example 1.2 and example 2.1 three different sizes of the solid shaped body, respectively, were investigated. The respective solid shaped bodies were scaled down to different levels of shrinkage.

The side crush strength of the 3D-printed shaped bodies was determined experimentally using a commercial material testing machine of the type BZ2.5/TS1S from Zwick, which allowed testing of the mechanical properties according to DIN EN ISO 7500-1:2018-06. For each type of solid shape body, 10 individual solid shape bodies were investigated. The applied analysis method included a preload of 0.5 N and a preload velocity of 10 mm/min. Analysis velocity was 1.6 mm/min. The solid shaped bodies were tested, whereby three positions were investigated allowing determination of side crushing strength A, side crushing strength B and side crushing strength C, as illustrated in FIGS. 3 to 5.

The diameter and the height of the individual solid shaped bodies were determined by means of a caliper. The weight of the solid shaped bodies was determined by an analysis balance. Typically, 10 shaped bodies were analyzed and the average value was considered.

TABLE 6

| | | | | Crushing | Crushing | Crushing |
|---|---|---|---|---|---|---|
| | Diameter | Height | Weight | strength A | strength B | strength C |
| Nb. | (mm) | (mm) | (g) | (N) | (N) | (N) |
| 1.2 | 16.69 | 9.96 | 1.52 | 38 | 28 | 243 |
| 1.2.1 | 14.20 | 8.72 | 1.12 | 76 | 33 | 162 |
| 1.2.2 | 13.03 | 7.97 | 0.87 | 70 | 37 | 150 |
| 2.1 | 16.75 | 9.99 | 1.68 | 50 | 45 | 136 |
| 2.1.1 | 14.18 | 8.64 | 1.05 | 47 | 49 | 150 |
| 2.1.2 | 13.02 | 7.95 | 0.80 | 45 | 44 | 144 |
| 2.2 | 18.21 | 13.31 | 2.53 | 36 | 35 | 63 |
| 2.3 | 18.18 | 13.55 | 2.55 | 81 | 64 | 117 |
| 2.4 | 17.29 | 12.52 | 2.28 | 91 | 47 | 120 |
| 3.1 | 17.61 | 11.49 | 2.51 | 40 | — | 174 |
| 3.2 | 17.86 | 11.76 | 2.59 | 17 | — | 53 |
| 3.3 | 18.67 | 14.13 | 3.22 | 53 | — | 116 |

The analysis of the 3D-printed samples showed an improvement of at least one of the three tested side crushing strengths, wherein a second of the tested three side crushing strengths is at least comparable to the solid shaped body of the comparative example 1.2 of the respective size for the mechanically improved examples, whereas example 3.2 offered a high axial dispersion coefficient and low pressure drop as shown in table 5. Further, for examples 2.1.1 and 2.1.2 a difference between crushing strength A and crushing strength B was small leading to a higher minimum SCS/particle volume.

In addition, solid shaped bodies were formed from catalytic material and analyzed as presented in table 7.

261.7 g of pulverulent nickel nitrate hexahydrate (Ni(NO₃)₂*6H₂O, purchased from Merck) were molten at about 100° C. and 400 g of pre-heated hydrotalcite powder (Pural MG30, purchased from Sasol), comprising 30 weight-% of MgO, were added stepwise during mixing. The preheating of the hydrotalcite powder was effectuated for 30 minutes at 130° C. in a convection oven. The obtained mixture comprising the nitrates salt and the hydrotalcite was allowed to cool down and subjected to a low temperature calcination in an air atmosphere, whereas the temperature was raises over three different temperature levels of 120° C., 180° C. and 280° C. to a target temperature of 425° C. The residence time for all temperature levels including the target temperature was 2 hours, respectively, and the heating rate was 2° C. per minute.

The product obtained from the low temperature calcination was mixed with 5 weight-%, referring to the mixture, of graphite supplied by Asbury as lubricant and pressed to tablets in a mechanical stamp press (XP1, purchased from Korsch) with a pressing force of 50 kN.

Subsequently, the tablets were subjected to a high temperature calcination at 950° C. in a muffle furnace in an air atmosphere for 4 hours to form the solid shaped bodies. The applied heating rate to reach 950° C. was 5° C. per minute. The stoichiometric composition of the resulting shaped bodies was Ni₁₄Mg₂₉Al₅₇.

TABLE 7

| | Tab- | | | | Crush- | Crush- | Crush- |
|---|---|---|---|---|---|---|---|
| | leting | | | | ing | ing | ing |
| | press | | | | strength | strength | strength |
| | force | Diameter | Height | Weight | A | B | C |
| Nb. | (kN) | (mm) | (mm) | (g) | (N) | (N) | (N) |
| 1.2 | 50 | 14.23 | 8.28 | 1.73 | 254 | 104 | 168 |
| 2.1 | 50 | 14.30 | 8.37 | 1.70 | 341 | 120 | 291 |

Made of the catalytic material, the produced solid shaped body of the inventive example 2.1 showed an improved crushing strength in all of the three variations of the test, compared to the solid shaped body according to the comparative example 1.2.

### REFERENCE NUMERALS

1 Solid shaped body
3 First base area
5 Second base area
6 Slit
7 Lateral area
8 Pitch angle
9 Flute
11 Opening
13 First radius
15 Second radius
17 Diameter of the solid shaped body 1
19 Height of the solid shaped body 1
21 Central opening
23 Peripheral opening
25 Third radius of peripheral opening 23
27 Fourth radius of central opening 21
29 First distance
30 Central axis of the solid shaped body 1
31 First center of central opening 21
33 Second center of peripheral opening 23
35 Dome height
37 Lobe
39 Tangential radius
41 Radial radius
43 Second distance
45 Third center of flute 9
47 Testing machine
49 Edge
51 Edge radius
53 Flute angle

1.-14. (canceled)

16. Solid shaped body (1) having a cylindrical form with a first base area (3), a second base area (5) and a lateral area (7),
wherein the solid shaped body (1) comprises a first number of flutes (9) in the lateral area (7), each extending from the first base area (3) to the second base area (5), and
a second number of openings (11), each extending from the first base area (3) to the second base area (5), and
wherein the second number of openings (11) is in a range from 2 to 8,
the second number of openings (11) is larger than the first number of flutes (9),
wherein a ratio between a first radius (13) of at least one flute (9) and a second radius (15) of at least one opening (11) is at least 1.15 and
wherein a ratio between the first radius (13) of the at least one flute (9) and the diameter (17) of the solid shaped body (1) is in a range from 0.15 to 0.40 and the solid shaped body possesses a basic shape of a circular cylinder.

17. Solid shaped body (1) according to claim 16, wherein the solid shaped body (1) comprises at least 3 flutes (9).

18. Solid shaped body (1) according to claim 16, wherein a ratio between a diameter (17) of the solid shaped body (1) and a height (19) of the solid shaped body (1) is in a range from 0.5 to 2.0.

19. Solid shaped body (1) according to claim 16, wherein the second number of openings (11) comprises one central opening (21) and at least one peripheral opening (23).

20. Solid shaped body (1) according to claim 19, wherein the at least one peripheral opening (23) has at least one third radius (25) and the at least one third radius (25) is equal for all of the at least one peripheral openings (23).

21. Solid shaped body (1) according to claim 19, wherein the central opening (21) has a fourth radius (27) and the forth radius (27) is smaller than the at least one third radius (25) of the at least one peripheral opening (23).

22. Solid shaped body (1) according to claim 19, wherein the first number of flutes (9) is equal to a third number of peripheral openings (23).

23. Solid shaped body (1) according to claim 19, wherein each of the at least one peripheral openings (23) is arranged between two flutes (9).

24. Solid shaped body (1) according to claim 19, wherein a ratio between a first distance (29) from a first center (31) of the central opening (21) to a second center (33) of the at least one peripheral opening (23) and the diameter (17) of the solid shaped body (1) is in a range from 0.20 to 0.40.

25. Solid shaped body (1) according to claim 16, wherein the first base area (3) and/or the second base area (5) are domed.

26. Solid shaped body (1) according to claim 25, wherein a ratio between a dome height (35) and the diameter (17) of the solid shaped body (1) is in a range from 0.05 to 0.40.

27. Solid shaped body (1) according to claim 16, wherein the solid shaped body (1) comprises a mixed oxide and the mixed oxide comprises oxygen, aluminum, nickel and at least one alkaline earth metal such as magnesium.

28. Solid shaped body (1) according to claim 16, wherein the solid shaped body (1) comprises a mixed oxide and the mixed oxide comprises oxygen, aluminum, cobalt and at least one rare earth metal such as lanthanum.

29. Use of the solid shaped body (1) according to claim 16 as a catalyst.
